(19) United States
(12) Patent Application Publication
(10) Pub. No.: US 2017/0068755 A1
(43) Pub. Date: Mar. 9, 2017

(54) TRANSPORTATION SCHEDULE EVALUATION

(71) Applicant: SAP SE, Walldorf (DE)

(72) Inventors: Mengjiao WANG, Shanghai (CN); Wen-Syan LI, Shanghai (CN); Lu CHEN, Shanghai (CN)

(21) Appl. No.: 14/846,838

(22) Filed: Sep. 7, 2015

(51) Int. Cl. G06F 17/50; G06F 17/18

(52) U.S. Cl. CPC G06F 17/5009; G06F 17/18

(57) ABSTRACT

The disclosure relates to an evaluation system that is able to simulate a large number of passengers, metro stations and trains. The evaluation system runs the simulated metro system inside a computer and shows the statistical status of each passenger, each metro station and each train. The passenger simulation can take into account various factors, such as weather, day, time and special events. Both historical and real-time passenger flows are data used to simulate passengers. The metro station simulation generates stations that have specific maximum volume and specific maximum throughput. The train will be simulated according to a specific train schedule. Both the metro station simulation and train simulation may use both virtual and real-world data. Finally, an evaluator will show the statistical information for passengers, stations and trains. For example, for the passengers, the system will show the average waiting/queuing/travelling time, which is very useful to evaluate the comfort level and satisfaction of passengers. For stations and trains, the system will show the peak passenger density, which is an important data used to evaluate safety levels and control the probability of a stampede.

### TECHNICAL FIELD

The present disclosure relates to computer systems, and more specifically, to a framework for evaluating schedules for a transportation system.

### BACKGROUND

A public transportation system or network, such as a metro or train system, forms an important part of a metropolitan area. Numerous people living in the metropolitan area rely on public transportation for various purposes. For example, regular users rely on public transportation for work or school commute while others rely on it for transportation from one location to another, such as meeting with friends, going to dinner or watching a movie.

The load on the transportation system is not constant. For example, the load on the transportation system may depend on various factors. These factors may include time of day, day of the week as well as type of day, such as weekdays, weekends and holidays. Furthermore, a metropolitan area is dynamic. For example, population changes may occur, such as growth or decline as well as shifts in the various parts of the metropolitan area. These various factors and dynamics of the metropolitan area make it difficult to adequately plan the transportation system.

The present disclosure is directed to a simulation system which can evaluate the transportation system and access the existing system based on historical information as well as using real-time information to effect changes to improve effectiveness of the transportation system.

### SUMMARY

A framework for evaluating a transportation system is described herein. In accordance with one aspect, a computer-implemented method is performed by a computer system for simulating the transportation system. The method includes providing a passenger flow data for the transportation system. The passenger flow data includes in-bound and out-bound passengers for stations of the transportation system. A schedule data for the transportation system is also provided. The schedule data includes schedules of trains of the transportation system. In addition, a map data of the transportation system is provided. The map data includes a station status and train status information of the transportation system. Simulation parameters for a configuration file used for simulating the transportation system is provided. Movement of people through trains and stations of the transportation system is simulated based on the passenger flow data, schedule data, map data and simulation parameters.

In another aspect, a transportation evaluation system is disclosed. The transportation system includes an input module with a flow data component containing a passenger flow data of the transportation system. The input module also includes a schedule data component containing a train schedule data of the transportation system and a map data component containing map data which includes a station status and train status information of the transportation system. In addition, the input module includes a configuration component which includes simulation parameters. The system also includes an evaluation module for performing simulation of the transportation system. The evaluation module includes a flow simulation component for simulating a passenger flow in stations of the transportation system based on the passenger flow data. In addition, the evaluation module includes a train status simulation component for simulating movement or status of trains based on the train schedule data. Also, a station status simulation component which simulates status of stations based on the map data is included. The system includes an output module which includes a display for visualizing results of the evaluation module.

In accordance with yet another aspect, a non-transitory computer-readable medium having stored thereon a program code is disclosed. The program code is executable by a computer for evaluating a transportation system which includes providing a passenger flow data for the transportation system. The passenger flow data includes in-bound and out-bound passengers for stations of the transportation system. A schedule data for the transportation system is also provided. The schedule data includes schedules of trains of the transportation system. In addition, a map data of the transportation system is provided. The map data includes station status and train status information of the transportation system. Simulation parameters for a configuration file used for simulating the transportation system is provided. Movement of people through trains and stations of the transportation system is simulated based on the passenger flow data, schedule data, map data and simulation parameters.

Simulating movement includes initializing a time counter to a first time interval (t=1), which is equal to simulation start time. A time interval of the simulation period is simulated based on the time counter. Simulating includes generating a passenger flow for the time interval, simulating a station status for the time interval, simulating a train status for the time interval and updating station and train status for the time interval t. The time counter is incremented to the next time interval (t=t+1), which is adding the simulation interval to t. The process determines if t is outside the simulation period. If t is not outside of the simulation period, then the time interval is repeated. On the other hand, if t is outside of the simulation period, then the process is terminated.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 shows a simplified diagram of an exemplary evaluation system;

FIG. 2 illustrates a simulation framework of the evaluation system;

FIG. 3 illustrates an example of a simulation page of a user interface (UI) of the evaluation system; and

FIG. 4 shows an embodiment of a simulation process flow by the evaluation system.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

A framework is provided for evaluating transportation schedules at stations of a transportation system. For example, the framework evaluates train schedules of the transportation system. The transportation system, for example, may be referred to as a metro system having different train lines or metro lines with stations. The metro system, for example, is a metro system of an area of interest, such as a city. Other of interests may also be useful. For example, the areas of interest may be larger or smaller than a city. Such areas of interest may include, for example, a city and its surrounding areas.

The framework simulates passenger flow under various conditions, such as weather, time, as well as events. Parameters may be altered to generate a different or new passenger flow. The framework simulates trains according to a schedule based on a given passenger flow. The schedule may be a currently used schedule. In other cases, the schedule may be a different schedule, such as a future proposed schedule or a test schedule for evaluation purposes. The framework may simulate the metro system based on currently implemented stations (e.g. real-world metro map). The framework also enables simulation using a virtual metro map. For example, the virtual map may be used to plan new stations or new metro lines. The simulation results may be useful for a metro operator to improve level of passenger comfort and satisfaction and reduce the level of risk due to overcrowding. Other applications for the framework may also be useful.

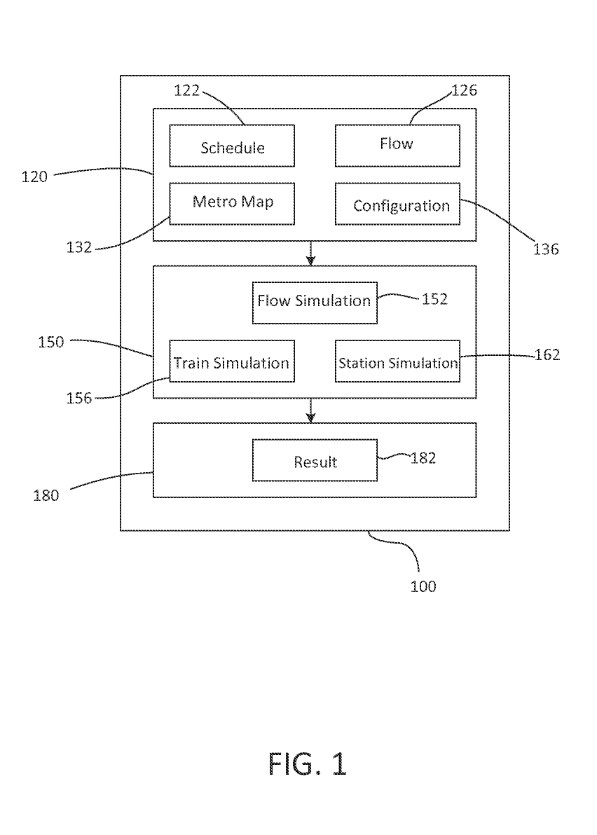

FIG. 1 shows a simplified block diagram of an exemplary embodiment of a metro evaluation system 100. The evaluation system, for example, may have a distributed architecture, such as a client-server architecture. In a distributed architecture, a server accessible by a client or user device is provided. Other types of architectures may also be useful.

A server may include one or more computers. A computer includes a memory and a processor. Various types of computers may be employed for the server. For example, the computer may be a mainframe, a workstation as well as other types of processing devices. The memory of a computer may include any memory or database module. The memory may be volatile or non-volatile types of non-transitory computer-readable media such as magnetic media, optical media, random access memory (RAM), read-only memory (ROM), removable media, or any other suitable local or remote memory component.

In a case where the server includes more than one computer, the computers are connected through a communication network such as an internet, intranet, local area network (LAN), wide area network (WAN) or a combination thereof. The servers, for example, are part of the same private network. The servers may be located in single or multiple locations. Other configurations of servers may also be useful.

As for the client or user device, it may be any computing device. A computing device, for example, includes a local memory and a processor. The computing device may further include a display. The display may serve as an input and output component of the user device. In some cases, a keyboard or pad may be included to serve as an input device. The memory may be volatile or non-volatile types of non-transitory computer-readable media such as magnetic media, optical media, RAM, ROM, removable media, or any other suitable memory component. Various types of processing devices may serve as a user device. For example, the user device may be a personal computer (PC), a tablet PC, a workstation, a network computer or a mobile computing device, such as a laptop, a tablet or a smart phone. Other types of processing devices may also be used.

The user device may communicate with the server through a communication network, such as the internet, intranet, LAN, WAN or a combination thereof. Other types of networks may also be useful. In some cases, the network may be a cloud.

A user may connect to the server using the user device. For example, the user device may include a browser for connecting to an analysis system. The user device may be referred to as the client side while the analysis system may be referred to as the server side. Other types of configurations for the analysis system may also be useful.

The metro evaluation system may be a web-based system. For example, users may access the system using a browser on the user devices. In one implementation, users may perform a managerial role. For example, the user may be a manager of the system by managing its operation. In some cases, users which are subscribers may access the system to provide or change settings related to the personalized recommendations.

As shown, the evaluation system includes an input module 120, a simulation module 150 and an output module 180. Providing other modules for the evaluation system may also be useful. The input and simulation modules, for example, may be located on the server while the output module may be located on the client device. Other configurations of the modules may also be useful.

The input module includes various components used by the simulation module. The various components, for example, serves as a data source. The data source contains data or information used by the simulation module. The data source includes a memory for storing the information. The data source may be a database or include a plurality of databases. The database, for example, may be a relational database or Structured Query Language (SQL)-based database, such as SAP HANA database from SAP SE. Other types of databases may also be useful. In one implementation, the input module includes a data schedule component 122, a data flow component 126, a data map component 132 and a configuration component 136. Providing other components may also be useful. For example, the data source may serve to store results of the simulation module.

The data schedule component, for example, stores the schedule of trains for the metro system. The data schedule component may be a metro schedule database. The database schema for a train schedule may include the following fields described in Table 1.

TABLE 1

| Field Name | Description |
|---|---|
| Train_ID | Train identification within the metro |
| | system |
| Station_ID | Station identification within the metro |
| | system |
| Arrival_Time_Timestamp | Arrival time of the train identified by the |
| | Train ID at the station identified by the |
| | Station ID |
| Departure_Time_Timestamp | Departure time of the train identified by |
| | the Train ID from the station identified by |
| | the Station ID |

Regarding the timestamp fields, they include date (day and year) and time. The database schema may include other fields. An entry in the schedule database is provided for every train which arrives and leaves a station according to the timestamp.

The schedule schema, for example, is for a specific train line. Different schedule schemas are provided for different train lines of the metro system. Other techniques for storing schedules may also be useful. For example, a Line_ID field may be provided which enables identification of different lines.

A user may search the metro schedule database and determine the sequence of entries related to a specific train and station. Table 2 illustrates an example of entries related to a specific train (Train_ID).

TABLE 2

| Train_ID | Station_ID | Arrival_Time | Departure_Time | Comments |
|---|---|---|---|---|
| #001 | A | 06:00.00 AM | 06:00.25 AM | 25 seconds at station A |
| #001 | B | 06:03.00 AM | 06:00.10 AM | 10 seconds at station B |
| #001 | C | 06:05.00 AM | 06:05.15 AM | 15 seconds at station C |
| #001 | D | 06:08.00 AM | 06:08.20 AM | 20 seconds at station D |

As shown, Table 2 is for a specific train of a specific date. Different dates may be provided with a different tables. Table 2, as illustrated, represents train #001 path from station A to D of the train line. This can be expanded to analyze train #001 path during a specific date, as well as any other train. The amount of time at a station may indicate the station's passenger flow rate for a specific line. For example, a greater amount time at a station may indicate a higher passenger flow rate while a lower amount of time may indicate a lower passenger flow rate. A passenger flow rate includes both passengers alighting and boarding the train. The passenger flow rate is described with respect to the data flow component below.

The data flow component, for example, stores the passenger flow rate for a station in the metro system. The flow component may be a station flow rate database. An embodiment of the data flow database schema may include the following fields described in Table 3.

TABLE 3

| Field Name | Description |
|---|---|
| Passenger_ID | Identification of passenger |
| In_Bound_Station_ID | Station which the passenger enters the metro |
| | system |
| In_Bound_Timestamp | Time which the passenger enters the station |
| Out_Bound_Station_ID | Station which the passenger leaves the metro |
| | system |
| Out_Bound_Time_Stamp | Time which the passenger leaves the station |

The database schema may include other fields. Regarding the timestamp fields, they include date (day and year) and time.

An entry in the data flow database is provided every time a passenger enters and leaves the metro system. This enables the system to track the flow of a specific passenger. For example, the system can track where and when a specific passenger enters and leaves the metro system. Such tracking is facilitated by the use of a metro tracking system. For example, the metro tracking system requires a passenger to swipe a metro pass or ticket when the passenger enters and leaves the metro system. The metro pass system, in the case of long term passes, tracks specific (named) passengers or in the case of daily tickets, may be a nameless passenger. In other cases, tracking of the passenger flow rates may be facilitated by manual or automatic tracking techniques of the passenger flow. For example manual tracking techniques may include surveyors manually counting passengers in and out of a station, camera feeds to facilitate manual or automatic counting of passengers in and out of a station or passenger surveys which provide passenger usage information. As for automatic tracking, it may be achieved by sensors. Other techniques of tracking passenger flow rates may also be useful.

A user may search the data flow database to determine when and where a passenger, based on a Passenger_ID, enters and leaves the metro system, as illustrated in Table 4.

TABLE 4

| Passenger_ID | In_Bound_Station_ID | In_Bound_Timestamp | Out_bound_Station_ID | Out_Bound_Timestamp |
|---|---|---|---|---|
| #P00001 | A | 07:00.00 AM | D | 07:08.00 AM |
| | | 2015-01-01 | | 2015-01-01 |
| #P00001 | D | 07:01.00 PM | A | 07:09.00 PM |
| | | 2015-01-01 | | 2015-01-01 |

Table 4, as illustrated, represents usage of passenger #P0001. As shown, passenger #P0001 traveled from station A to station D in the morning and station D to station A in the evening. This may possibly represent the work commute of passenger #P0001.

The data map component stores a map of the transportation system. The data map component may be a station and train database. For example, the data map component contains the information of each station in the transportation system. Such station information includes a location, maximum passenger capacity, an interchange station, and number of entrances/exits. Providing other station information may also be useful. The map component also contains train information. Such train information is related to a specific train. Such train information may include, for example, amount of cargo or storage space, number of seats and maximum passenger capacity. Providing other types of train information may also be useful. Information contained in the map component may be useful when evaluating safety levels and setting alerts. Alerts, for example, may be when capacity is exceeded, such as train and station capacitor. Other types of alerts may also be useful.

The configuration component contains a simulation configuration file. The configuration file stores simulation parameters of the simulation module. The simulation parameters may include a time interval length, a simulation period which includes simulation start time and simulation end time, and special events. A description of the different parameters is provided in Table 5.

TABLE 5

| Parameter | Description |
|---|---|
| Time interval length | The length of the discrete interval which the |
| | simulation period is divided into. For |
| | example, the time interval may be 1 second, |
| | 5 seconds or 1 minute in length. Other |
| | durations may also be useful. |
| Simulation start time | The start time of the simulation period. |
| Simulation end time | The end time of the simulation period. |
| Special event | If yes, we also need the start and end times |
| | of the event and details of stations nearby |
| | the event. |

Providing other simulation parameters may also be useful. For example, simulation parameters may include data sources. In a case where there are special events, additional parameters may be provided if selected. For example, start and end times of the special event, nearby stations and number of event goers. Other special event parameters may also be provided.

As an example, assuming we want to simulate a specific day, such as Monday, the simulation start time would be the time which the first train of the system starts running on Monday and the simulation end time would be the time which the last train of the system stops running on Monday. Simulation period may be separated into discrete 1 minute time periods. In a case where a special event is simulated, the start and end times of the special event would be provided as well as stations which are nearby the event. The simulation period could be 1 to 2 hours before the start of the event to 1 hour after the event. Special events, for example, may be sporting games or concerts. Other types of special events may also be useful.

The simulation module includes various components for simulating the transportation system using the historical data from the various components of the schedule module as well as the manually created data by the user. In one embodiment, the simulation module includes a flow simulation component 152, a train simulation component 156 and a station simulation component 162. Providing other types of components may also be useful. The various components of the simulation module may cooperate to simulate movement in the transportation system for schedule evaluation or recommendation.

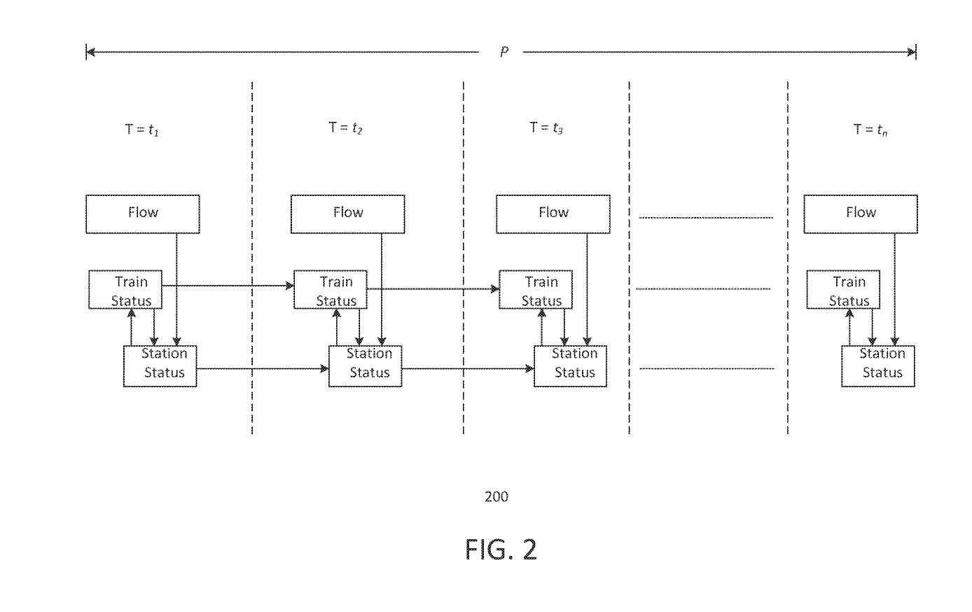

FIG. 2 illustrates an embodiment of a simulation framework 200 for simulating movement within a transportation system. As shown, the simulation framework simulates movement within the transportation system for time period P. The time period P is a continuous time period. In one embodiment, the continuous time period P is segmented into n discrete time intervals from t₁ to tₙ. In one embodiment, the time intervals are equal time intervals. Providing unequal time intervals may also be useful. The time intervals, for example, may be from 1 second to 10 minutes. Providing longer time intervals may also be useful. The longer the time interval, the more coarse the simulation. Conversely, the shorter the time interval, the finer the simulation. The user can select the time interval as a simulation parameter. This enables the user to tailor the granularity of the simulation as desired.

The simulation framework, as shown, simulates a passenger flow, train status and station status. In one embodiment, the simulation framework simulates the passenger flow, train status and station status for each station at each time interval. For example, the passenger flow, train status and station status of each station are simulated for a given time interval (e.g., x time interval). The changes in the passenger flow, train status and station status during the x^{th} time interval are used to simulate the movement of each station for the next time interval (e.g., x+1 time interval). For example, the passenger flow, train status and station status of each station are simulated for T=t₁. The changes in the passenger flow, train status and station status during t₁ are used to simulate the movement of each station for T=t₂. The arrows indicate the dependency relationships. For example, the train status at time interval t₂ depends on the passenger flow at t₂, the train status at time interval t₁ and the station status at time interval t₂.

In one embodiment, the simulation framework simulates the passenger flow status at each time frame for each station. The station status is simulated and updated based on the passenger flow. The train status simulation is performed. If a train or trains arrive at the station, the train status and station status is updated.

The flow simulation component simulates the passenger flow. In one embodiment, the passenger flow simulation component simulates the passenger flow from data contained in the data passenger flow component. In one embodiment, the passenger flow is simulated using equation 1 as follows:

$${np}_{simulate} = α * \frac{1}{N} * {\sum }_{i = 0}^{N} np\_historical \_i \qquad ( Equation 1 )$$

where,

npₛᵢₘᵤₗₐₜₑ is the simulated in-bound passenger flow at a station at a desired time interval,

N is the number of most recent historical in-bound passenger flow at a station at the desired time interval

a is the trending parameter, and

np_historical_i is the i^{th} of N historical passenger flow at a station at the desired time interval.

The trending parameter a provides a user with flexibility in simulating the passenger flow based on recent trends. For example, the trending parameter a enables a user to modify the historical data to create real time data for simulating the passenger flow. The trending parameter enables the user to increase, decrease or maintain historical data for the passenger flow simulation based on the value of a. A value greater than 1 increases historical values, less than 1 decreases historical values and equal to 1 maintains historical values. The real-time data, as discussed, is based on historical data via a. In other cases, real-time data may be provided or generated without being based on the historical data.

As an example, an increase in population of a city may indicate that the number of passenger flow would likely be higher than the historical data. In such a case, a tread parameter a of greater than 1 would be used. Conversely, a decrease in population may indicate that the number of in-bound passengers would likely be lower than the historical data. Also, a stable population may indicate that the historical number should be accurate. Other factors may impact trend of the passenger flow. A trend parameter value greater than 1 indicates an increasing trend, a trend parameter value less than 1 indicates a decreasing trend while a trend parameter value equal to one indicates a stable trend. For example, if the number of in-bound passengers are expected to increase by 5%, the trend parameter value is set at 1.05.

The flow simulation component can be used to simulate a passenger flow within the metro system. For example, the passenger flow can be simulated at any time interval within any time period P as desired. The passenger simulation component flow can employ historical data, real-time data or a combination thereof. The flow simulation component can be used to simulate in-bound passengers to determine a distribution of in-bound passengers. The flow simulation can simulate the destination station of the in-bound passengers. For example, the flow simulation can simulate out-bound passengers of each station. Out-bound passenger information can be used to adjust train status and station status.

Using equation 1, passenger in-bound flow at each station at each time interval within the time period P can be generated. Generally the passenger flow follows patterns which may be determined by many factors such as week, day, hour and weather. For example, the number of passengers during a workday at 8:00 AM may be larger than the number of passengers during a weekend or non-workday at 8:00 AM. On the other hand, good weather during the weekend may cause an increase of in-bound passenger flow in stations near point of interest (POI) locations.

An example of in-bound passenger flow simulation is provided. The example simulates an in-bound passenger flow for the desired time period P of a workday, such as Monday, from 8:00 AM to 9:00 AM with a time interval of 1 minute. The configuration parameters of the configuration file is as follows:

a) time interval length=1 minute

b) simulation start time=Monday, 8:00 AM

c) simulation end time=Monday, 9:00 AM

d) Special event=No

The parameters of the configuration file may be entered by the user using, for example, a user interface (UI). Other techniques for providing information to the system may also be useful. For example, the system may provide dialog boxes for the user requesting various information needed for the simulation. The UI, for example, may include a menu bar with different options for navigating the evaluation system. In one embodiment, the UI may include a simulation option. When selected, a simulation page may be displayed, requesting a user to input configuration parameters to generate the configuration file. The trend parameter a and number of historical flow parameter N may be global parameters. For example, the global parameters may have default values which may be pre-defined. The default values for a may be equal to 1 and N may be equal to 3. Other default values for the global parameters may also be useful. The system may provide an option for a user to override the default values of one or more global parameters with the user's desired values. For example, the menu bar may include an option to change the values of the global parameters.

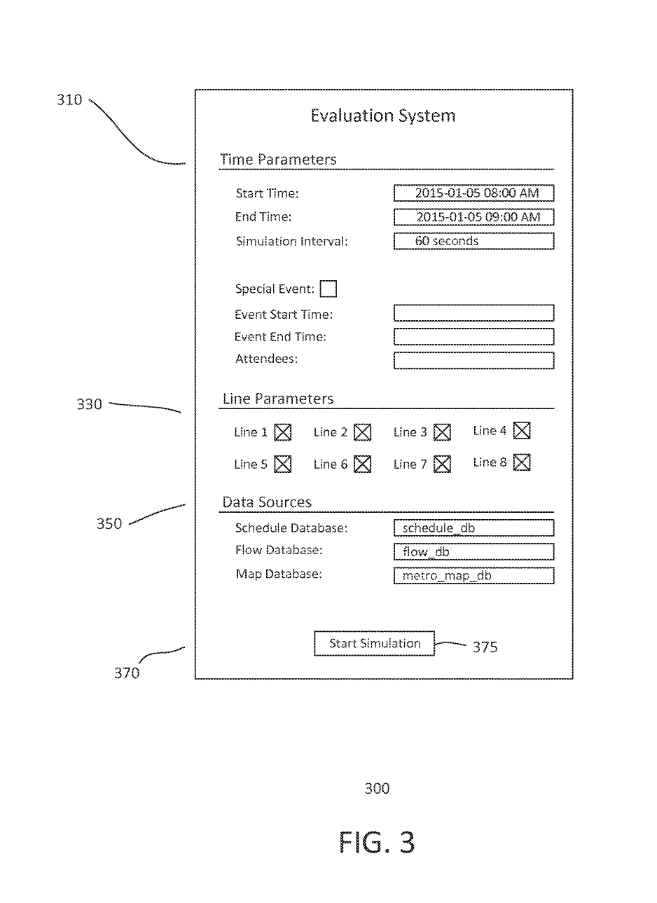

FIG. 3 illustrates an example of a simulation page 300 of a UI of the evaluation system. As shown, the UI includes various sections for performing a simulation. In one embodiment, the UI includes a Time Parameters section 310, a Line Parameter section 330, a Data Sources section 350 and a Simulation section 370. The Time Parameters section, Line Parameter section, and Data Sources section provide configuration parameters for the configuration file. Providing a simulation page with other sections or other configurations of the UI may also be useful.

The Time Parameters section includes various input units for the user to provide time information related to the simulation. As shown, the Time Parameters section includes a Start Time input unit, an End Time input unit, and a Simulation Interval input unit. A user may enter the start time and end time of the simulation (simulation period P) in the Start Time and End Time input units. The time may be in a format which includes a date. For example, the time format may be YYYY-MM-DD HH:MM, where YYYY is equal to year, MM is the month of the year and DD is the day of the month. The time format may include an AM or PM designation for a 12 hour time format. Other time formats may also be useful. The user may enter the desired simulation interval in the Simulation Interval input unit. As shown, the simulation period P is for Monday Jan. 5, 2015 from 8:00 AM to 9:00 AM with a simulation interval of 60 seconds.

The Time Parameters section includes a Special Event input unit. The special event option is selected by, for example, clicking on the Special Event box to simulate a special event. When the option is selected, additional information is provided to the system. For example, the start time and end time of the event are provided in the Event Start Time and Event End Time input units. Also, the number of event goers is provided in the Attendees input unit.

The Line Parameters section includes the various lines of the transportation system. Illustratively, the system includes 8 different train lines. The system may include other number of train lines. The user can select 1, some or all the train lines for the simulation. A train line can be selected by clicking on the box after each train line. As shown, all train lines of the transportation system are selected for the simulation.

The Data Sources section defines which data sources to use for the simulation. As shown, the Data Sources section include a Schedule Database input unit, a Flow Database input unit, and a Map Database input unit. The various Database input units define which database files to use for the simulation. The user may define the historical database files to use for the simulation to generate a baseline simulation. The simulation may be modified by providing different data, such as new stations in a modified map database file, a passenger flow in a modified passenger flow database file and a new schedule in a modified schedule database file. The simulation can easily use different data based on modified database file or files providing by the user.

After the information is provided by the user, the system may perform the simulation. For example, the user may click on the Start Simulation button 375 in the Simulation section. This causes the system to simulate the transportation system based on the information provided.

Referring back to FIG. 2, based on the configuration file, the flow simulation component simulates the in-bound passengers for each station at each time interval within the simulation time period P using equation 1. For example, the in-bound passenger flow is simulated using three most recent Monday in-bound passenger data for the desired time interval stored in the data flow component. The flow simulation component simulates the first time interval of the simulation time period. For example, the time interval from 8:00 AM to 8:01 AM is simulated first for each station. The passenger flow simulation component calculates the in-bound passengers for each station. For example, a simplified simulation of passenger in-bound flow for four stations (Stations A, B, C and D) using the three most recent Mondays at the time interval from 8:00 AM to 8:01 AM is shown in Table 6.

TABLE 6

| N Historical Day | In-bound Stations | Number of Passengers |
|---|---|---|
| N = 1 | Station A | 80 |
| | Station B | 70 |
| | Station C | 60 |
| | Station D | 60 |
| N = 2 | Station A | 70 |
| | Station B | 70 |
| | Station C | 50 |
| | Station D | 90 |
| N = 3 | Station A | 60 |
| | Station B | 60 |
| | Station C | 50 |
| | Station D | 75 |

In a case where a station is an interchange station, the interchange station may be considered as multiple stations. For example, the simulation process calculates in-bound passengers to the station from different train lines. In a case where a station is an interchange station for 3 lines, it is simulated as 3 stations on each of the 3 lines.

From equation 1, the average in-bound passengers (npₛᵢₘᵤₗₐₜₑ) at each station is provided in Table 7.

TABLE 7

| In-bound Stations | npₛᵢₘᵤₗₐₜₑ |
|---|---|
| Station A | 70 |
| Station B | 67 |
| Station C | 53 |
| Station D | 75 |

The npₛᵢₘᵤₗₐₜₑ is calculated using a trend parameter a equal to 1. The data can be adjusted to real-time data by using a trend parameter a which is greater or less than 1.

Using the N days of historical data, the flow simulation component can determine the destination stations of the in-bound passengers at each station. For example, Table 8 shows destination stations of in-bound passengers of Station D. In the simplified simulation, the metro system includes four stations. As such, the in-bound passengers must all go to one of Stations A, B and C.

TABLE 8

| N Historical Day | Destination Stations | Number of Passengers |
|---|---|---|
| N = 1 | Station A | 10 |
| | Station B | 20 |
| | Station C | 30 |
| N = 2 | Station A | 20 |
| | Station B | 30 |
| | Station C | 40 |
| N = 3 | Station A | 15 |
| | Station B | 25 |
| | Station C | 35 |

Once the in-bound station and the out-bound station of a passenger are determined, the system will automatically assign the shortest path for the passenger. For example, the system assigns a passenger to a train (assigned train) to board from the in-bound station to the out-bound station with the shortest path. The shortest path may include connecting to a different train at an interchange station.

The total number of out-bound passengers for each day in the time interval of interest from Station D is equal to the total number of in-bound passengers at Station D, as illustrated in Table 9.

TABLE 9

| Destination Station | N = 1 | N = 2 | N = 3 | Total |
|---|---|---|---|---|
| Station A | 10 | 20 | 15 | 45 |
| Station B | 20 | 30 | 25 | 75 |
| Station C | 30 | 40 | 35 | 105 |
| Total | 60 | 90 | 75 | 225 |

As shown, the number of passengers of N historical days from Station D who went to Station A, Station B and Station C is 45, 75 and 105, respectively, totaling to 225. Percentage wise, 20% of the passengers went to Station A, 33% of the passengers went to Station B and 47% of the passengers went to Station C. The actual numbers of in-bound and out-bound passengers can be changed by, for example, changing the trending parameter a. Although the actual numbers can be changed, the percentage can be maintained by the flow simulation component. For example, instead of 225 in-bound passengers in Station D, the flow simulation can be adjusted to simulate 100 in-bound passengers in Station D, the percentage can be adjusted accordingly. For example, in such a case, 20 in-bound passengers of Station D will go to Station A, 33 in-bound passengers of Station D will go to Station B and 47 in-bound passengers of Station D will go to Station C.

Once the in-bound station and the out-bound station of a passenger are determined, the system will automatically assign the shortest path for the passenger. For example, the system assigns a passenger to an assigned train to board from the in-bound station to the out-bound station with the shortest path. The shortest path may include connecting to a different train at an interchange station.

As discussed, the flow simulation component can be configured to simulate special events. For example, the special events may be sporting games, such as soccer or baseball as well as other types of special events such as concerts or any type of shows.

In the case of special events, a combination of historical data may be used. For example, the days with and without special events may be used. The special events may be targeted by the type of special events. For example, days with the same type of special events are used, such as games or concerts. If the special event occurs on Monday, Mondays with and without the special event may be used. Special events generally cause an increase in passengers at the station or proximate to the event (event station). Event station may include a plurality of stations which are proximate to the event. For example, there is an increase of out-bound passengers at the event stations prior to the beginning of the event and in-bound passengers at the event stations after the end of the event.

The flow simulation, in one embodiment, includes differentiating normal or regular in-bound and out-bound passengers of the event station. In a case where the event station includes more than one station, the in-bound and out-bound passengers are simulated for the event stations. In a preferred embodiment, flow simulation is performed at the event station after the end of the event. Typically, this is the case where event goers are returning home from the event. On the other hand, event goers may go at different times prior to the beginning of the event. The historical information may be employed to determine passenger flow for events.

Passenger flow data for events may be analyzed to determine in-bound passenger and out-bound passenger flow information for the event station. In one embodiment, flow data during the pre-event period is analyzed to identify non-regular and regular passengers having a destination station as the event station. The pre-event period, for example, may be 2 hours prior to the event. Other lengths for the pre-event period may also be useful. The pre-event period should be selected to capture a majority of event goers. The pre-event period may overlap the start of the event. Non-regular passengers may be categorized as event goers using the metro system.

The user may define regular passengers. Those that do not fit into the definition are categorized as non-regular passengers. Regular passengers may be those that fit into a selected category as follows:
a) a passenger who comes to the event station every day in the past week;
b) a passenger who comes to the event station every workday in the past week; or
c) a passenger who comes to the event station at least three workdays in the past week.
   Other categories for determining a regular passenger may also be useful. For example, another category could be for a passenger who comes to the event station previously during the pre-event period when there is no event.

Segregating non-regular and regular passengers, as discussed, enables the determination or estimation of passengers attending the event. The originating station of the event goers (e.g., non-regular passengers) can be determined. For example, the passenger data includes originations and destinations. By knowing the originating station of the event goers, it can be assumed that event goers will return to the originating stations from the event stations after the end of the event.

The train simulation component simulates train movement or status. The train simulation is based on the metro train schedule and information contained in the data schedule component. The train status simulation may be adjusted by passenger flow from the flow simulation component. For example, the train status simulation is based on the metro schedule and passenger flow. When a train arrives at a station at a time interval, passengers get on and off the train according to the passenger flow simulated by the flow simulation component. For example, passengers alight the train based destination station and board the train based on assigned train from the passenger flow simulation. The number of passengers in the train and in the station will be changed accordingly.

In one embodiment, the train simulation component, at each time interval, determines which train arrives at which station. This is calculated for each station and each train of the metro system based on the train schedule. The system updates the train status based on the passenger flow information. For example, if a train of interest arrives at a station of interest at the time interval, the status is updated. In one embodiment, the train simulation component calculates train status of a train of interest at station of interest based on equation 2 below:

np(train_n)ₜ=np(train_n)ₜ₋₁−np_getoff(train_n,station_n)+np_geton(train_n,station_n) (Equation 2)

where,

np(train_n)ₜ is status of the train of interest at time interval t,

np(train_n)ₜ₋₁ is the status of the train of interest at previous time interval t−1

np_getoff(train_n, station_n) is the number of passenger getting off the train of interest at the station of interest at time t, and

np_geton(train_n, station_n) is the number of passenger getting on the train of interest at the station of interest at time t.

As an example, assume train 100 is scheduled to arrive at station A at time interval t. Train 100 at the previous time interval (t−1) has 20 passengers. According to the passenger flow simulation, 5 passengers are getting off at station A at time t and all are leaving station A. In addition, 4 passengers are getting onto train 100 at station A at time t. The passenger capacity of train 100 is 50 passengers, according to the train status information in the data schedule component. At time t, the status of train 100 is updated. For example, the number of passengers is updated to 19 based on equation 2. Since the number of passengers is less than the train capacity, no alerts are provided by the system.

In the event the number of passengers in the train of interest exceeds the maximum capacitor, the number of passengers is reduced to the number which is at capacity. This would mean that the number of passengers boarding cannot cause the train to exceed the train's capacity. In some cases, the user may set a threshold passenger limit which is below stated capacity, such as 90%. The limits, of course are for simulation and evaluation purposes. The train simulation component calculates the train status for each station at each time interval.

The station simulation component simulates the status of stations in the metro system. The station simulation is based on information contained in the map component. The station status may be adjusted by the passenger flow and train status from the flow and train simulation components. For example, the station status simulation is based on the station information contained in the map component, information from the train status and passenger flow simulations. The status of a station is affected by an incoming train and incoming (in-bound) passengers. The status of a station is adjusted base on incoming train and in-bound passengers.

In one embodiment, the station simulation component, at each time interval, determines station status. The station status, in one embodiment, is calculated based on equation 3 below:

np(station_n)t=np(station_n)ₜ₋₁+np_inbound(station_n)ₜ (Equation 3)

where,

np(station_n)ₜ is the status of the station of interest at time t,

np(station_n)ₜ₋₁ is the status of the station of interest at time t−1, and

np_inbound(station_n)ₜ is the number of in-bound passengers at the station of interest at time t.

For example, if a train arrives at the station of interest at time t, the station status is adjusted based on equation 4 below:

np(station_n)t=np(station_n)ₜ₋₁+np_inbound(station_n)ₜ−np_geton(train_n,station_n) (Equation 4)

where,

np(station_n)ₜ is status of the station of interest at time interval t,

np(station_n)ₜ₋₁ is the status of the station of interest at previous time interval t−1,

np_inbound(station_n)ₜ is the number of passengers entering the station of interest at time t, and

np_geton(train_n, station_n) is the number of passengers getting on the train of interest at the station of interest at time t.

Equation 4 assumes that passengers getting off the train are leaving the station of interest. In the case of an interchange station, equation 4 can be modified to include passengers alighting a train who would remain in the station to catch a connecting train. For example, equation 4 can add np_connection(train_n, station_n), which are passengers getting off the train of interest who are connecting to another train at the station of interest.

As an example, assume train 100 is scheduled to arrive at station A at time interval t. Train 100 at the previous time interval (t−1) has 20 passengers. According to the passenger flow simulation, 5 passengers are getting off at station A at time t and all are leaving station A. In addition, 4 passengers are getting onto train 100 at station A at time t. The passenger capacity of train 100 is 50 passengers, according to the train status information in the data schedule component. At time t, the status of train 100 is updated. For example, the number of passengers is updated to 19 based on equation 2. Since the number of passengers is less than the train capacity, no alerts are provided by the system.

As discussed, the evaluation system can simulate movement in a metro system, including passenger flow, trains and station status. Regarding the passenger flow, it may be based on historical passenger flow data, real-time passenger flow data or a combination thereof. The system provides a user interface which allows a user to simulate the passenger flow based on various input parameters. The input parameters may be provided in a simulation configuration file. The simulation system simulates the metro system based on a train schedule. The train schedule may be based on a current train schedule or modified schedule to evaluate the performance of the metro system. The station status can also be simulated based on a current map of the metro system. The map may be adjusted to add stations or lines to evaluate the metro system.

Results 182 of the simulation may be displayed to the user by the output module. For example, the results may be displayed on a display of the user device. The user device, for example, may be a client device in the case of a client/server architecture. In other cases, the display may be part of the evaluation system.

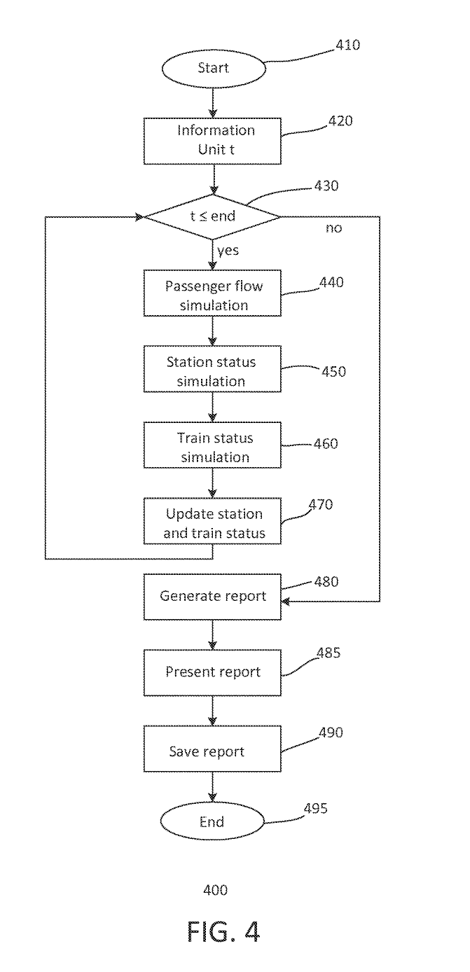

FIG. 4 shows an embodiment of a simulation process flow 400 by the evaluation system. As shown, the system is initiated by a user to start a simulation at step 410. For example, a user may select the start simulation in the UI. This causes the system to request configuration information or parameters from the user for the simulation at step 420. The configuration information includes start and end times of the simulation period, simulation time interval, lines to be simulated, as well as data used. Additionally, the simulation may include special event information if simulation is for a special event. Providing other input information may also be useful.

At step 430, the simulation commences based on the simulation information provided by the user. The system may be initialized for the simulation. For example, t is set to the first time period of the simulation period. If t is not at the end of the simulation period, the process proceeds to step 430. For example, if t is less than or equal to the end time of the simulation period, the process proceeds to step 430.

At step 440, the system generates a passenger flow for time interval t at each station of each line to be simulated. For example, the system generates the passenger flow based on the database provided by the user in the Flow Database input unit of the Data Sources section.

At step 450, the system generates a station status for time interval t for each station of each line to be simulated. For example, the system generates the station status based on the map database provided by the user in the Map Database input unit of the Data Sources section.

At step 460, the system generates a train status for time interval t for each station of each line to be simulated. For example, the system generates the train status based on the schedule database provided by the user in the Schedule Database input unit of the Data Sources section.

The system, at step 470 updates the station and train status for time interval t based on the passenger flow, station status and train status simulations. After updating the station and train status, the system increments to the next time interval and returns to step 430. The process repeats the various simulations if t is less than or equal to the end of the simulation period. On the other hand, if t is greater than the end of the simulation period, the simulation terminates and the process proceeds to step 480. At step 480, the system generates a simulation report. The simulation report contains results of the simulation, such as the passenger flow, train status and station status for each time interval of the simulation period. The simulation report is presented to the user at step 485 for review. The simulation report may be saved by the user at step 490. After saving the simulation report, the simulation process terminates at step 495.

As described, the various modules of the evaluation system may be embodied as an application. For example, the various modules may be embodied as a software application. The modules may be integrated into a client/server or stand-alone software application. The source code or codes of the application may be compiled to create an executable code. The codes, for example, may be stored in a storage medium such as one or more storage disks. Other types of storage mediums may also be useful.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A computer-implemented method performed by a computer system for simulating a transportation system comprising:
providing a passenger flow data for the transportation system, wherein the passenger flow data comprises in-bound and out-bound passengers for stations of the transportation system;
providing a schedule data for the transportation system, wherein the schedule data comprises schedules of trains of the transportation system;
providing a map data of the transportation system, wherein the map data comprises a station status and train status information of the transportation system;
providing simulation parameters for a configuration file used for simulating the transportation system; and
simulating movement of people through trains and stations of the transportation system based on the passenger flow data, schedule data, map data and simulation parameters.

2. The computer-implemented method of claim 1 wherein the simulation parameters comprise:
a simulation start time parameter;
a simulation end time parameter, wherein the simulation start time and simulation end time defines the simulation period; and
a simulation interval parameter, which is the length of discrete time intervals into which the simulation period is divided.

3. The computer-implemented method of claim 2 wherein simulating movement comprises:
initializing a time counter to a first time interval (t=1), which is equal to simulation start time;
simulating the time interval of the simulation period based on the time counter, wherein simulating comprises
generating the passenger flow for the time interval,
simulating the station status for the time interval,
simulating the train status for the time interval,
updating the station and train status for the time interval t, and
incrementing the time counter to the next time interval (t=t+1), which is adding the simulation interval to t; and
determining if t is outside the simulation period, wherein
if t is not outside of the simulation period, then repeat simulating the time interval, and
if t is outside of the simulation period, then terminate simulating.

4. The computer-implemented method of claim 3 wherein t is outside the simulation period if t is greater than the simulation end time.

5. The computer-implemented method of claim 3 wherein simulating the passenger flow comprises
$${np}_{simulate} = α * \frac{1}{N} * {{\sum }_{i = 0}}^{N} np\_historical \_i$$
where,
npₛᵢₘᵤₗₐₜₑ is the simulated in-bound passenger flow at a station at a desired time interval,
N is the number of most recent historical in-bound passenger flow at a station at the desired time interval,
a is the trending parameter, and
np_historical_i is the i^{th} of N historical passenger flow at a station at the desired time interval.

6. The computer-implemented method of claim 5 wherein a and N are additional simulation parameters.

7. The computer-implemented method of claim 6 wherein a and N are global parameters.

8. The computer-implemented method of claim 5 wherein simulating the passenger flow comprises:
identifying an in-bound station and out-bound station of each passenger; and
assigning a shortest path for each passenger.

9. The computer-implemented method of claim 8 wherein simulating the station status comprises
np(station_n)ₜ=np(station_n)ₜ₋₁+np_inbound(station_n)ₜ
where,
np(station_n)ₜ is the status of the station of interest at time t,
np(station_n)ₜ₋₁ is the status of the station of interest at previous time t−1, and
np_inbound(station_n)ₜ is the number of in-bound passengers at the station of interest at time t.

10. The computer-implemented method of claim 8 wherein simulating the train status comprises
np(train_n)ₜ=np(train_n)ₜ₋₁−np_getoff(train_n,station_n)+np_geton(train_n,station_n)
where,
np(train_n)ₜ is status of the train of interest at time interval t,
np(train_n)ₜ₋₁ is the status of the train of interest at previous time interval t−1,
np_getoff(train_n, station_n) is the number of passengers getting off the train of interest at the station of interest at time t, and
np_geton(train_n, station_n) is the number of passengers getting on the train of interest at the station of interest at time t.

11. The computer-implemented method of claim 3 wherein:
the passenger flow data comprises historical passenger flow data from a flow database;
the schedule data is from a schedule database; and
the map data of the transportation system is from a map database.

12. The computer-implemented method of claim 3 wherein simulating movement of the transportation system is based on current passenger flow data, current schedule, current map, or a combination thereof.

13. The computer-implemented method of claim 12 wherein the current passenger flow data, current schedule and current map comprise real-time data which is modified from historical data.

14. A transportation evaluation system comprises:
an input module, the input module includes
a flow data component containing a passenger flow data of the transportation system,
a schedule data component containing a train schedule data of the transportation system, and
a map data component, the map data component containing map data which includes a station status and train status information of the transportation system;
an evaluation module for performing a simulation of the transportation system, the evaluation module includes
a flow simulation component for simulating a passenger flow in stations of the transportation system based on the passenger flow data,
a train status simulation component for simulating movement or status of trains based on the train schedule data, and
a station status simulation component for simulating status of stations based on the map data; and
an output module, the output module includes a display for visualizing results of the evaluation module.

15. The system of claim 14 wherein the simulation parameters comprise:
a simulation start time parameter which is the start of the simulation period;
a simulation end time parameter which is the end of the simulation period; and
a simulation interval parameter, which is the length of the discrete time intervals into which the simulation period is divided.

16. The system of claim 15 wherein:
the simulation period is divided into n discrete time intervals from t=t₁ to t=tₙ, where 1 is the first interval and n is the last interval of the simulation period;
the flow simulation component simulates passenger flow at each station of the transportation system for each time interval of the simulation period;
the station status simulation component simulates status of each station for each time interval t of the simulation period component for simulating passenger flow in stations of the transportation system based on passenger flow data;
the train status simulation component simulates train status at each time interval; and
updates the station and train status for each time interval.

17. The system of claim 16 wherein the flow simulation component simulates the passenger flow at each station using
$${np}_{simulate} = α * \frac{1}{N} * {{\sum }_{i = 0}}^{N} np\_historical \_i$$
where
npₛᵢₘᵤₗₐₜₑ is the simulated in-bound passenger flow at a station at a desired time interval,
N is the number of most recent historical in-bound passenger flow at a station at the desired time interval,
a is the trending parameter, and
np_historical_i is the i^{th} of N historical passenger flow at a station at the desired time interval.

18. The system of claim 16 wherein the station status simulation component simulates station status using
np(station_n)ₜ=np(station_n)ₜ₋₁+np_inbound(station_n)ₜ
where,
np(station_n)ₜ is the status of the station of interest at time t,
np(station_n)ₜ₋₁ is the status of the station of interest at previous time t−1, and
np_inbound(station_n)ₜ is the number of in-bound passengers at the station of interest at time t.

19. The system of claim 16 wherein the train status simulation component simulates the train status using
np(train_n)ₜ=np(train_n)ₜ₋₁−np_getoff(train_n,station_n)+np_geton(train_n,station_n)
where,
np(train_n)ₜ is status of the train of interest at time interval t,
np(train_n)ₜ₋₁ is the status of the train of interest at previous time interval t−1,
np_getoff(train_n, station_n) is the number of passengers getting off the train of interest at the station of interest at time t, and
np_geton(train_n, station_n) is the number of passengers getting on the train of interest at the station of interest at time t.

20. A non-transitory computer-readable medium having stored thereon a program code, the program code executable by a computer for evaluating a transportation system comprising:
providing a passenger flow data for the transportation system, wherein the passenger flow data comprises in-bound and out-bound passengers for stations of the transportation system;
providing a schedule data for the transportation system, wherein the schedule data comprises schedules of trains of the transportation system;
providing a map data of the transportation system, wherein the map data comprises a station status and train status information of the transportation system;
providing simulation parameters for a configuration file used for simulating the transportation system; and
simulating movement of people through trains and stations of the transportation system based on the passenger flow data, schedule data, map data and simulation parameters, wherein simulating movement comprises
initializing a time counter to a first time interval (t=1), which is equal to simulation start time,
simulating the time interval of the simulation period based on the time counter, wherein simulating comprises
generating a passenger flow for the time interval,
simulating a station status for the time interval,
simulating a train status for the time interval,
updating station and train status for the time interval t, and
incrementing the time counter to the next time interval (t=t+1), which is adding the simulation interval to t; and
determining if t is outside the simulation period, wherein
if t is not outside of the simulation period, then repeat simulating the time interval, and
if t is outside of the simulation period, then terminate simulating.
